(19) United States
(12) Patent Application Publication
(10) Pub. No.: US 2019/0012756 A1
(43) Pub. Date: Jan. 10, 2019

(54) METHOD AND SYSTEM FOR PROVIDING INFORMATION REGARDING WITH DELIVERY ARTICLE USING AUGMENTED REALITY

(71) Applicant: SK PLANET CO., LTD, Seongnam-si (KR)

(72) Inventors: Ju Hyeun HAN, Yongin-si (KR); Young Seog Lee, Seoul (KR); Un Dong Chang, Gunpo-si (KR)

(21) Appl. No.: 16/027,827

(22) Filed: Jul. 5, 2018

(30) Foreign Application Priority Data
Jul. 5, 2017 (KR) 10-2017-0085660

(51) Int. Cl. G06Q 50/28; G06K 19/06; G06T 19/00; G06T 19/20

(52) U.S. Cl. CPC G06Q 50/28; G06K 19/06037; G06K 9/00006; G06T 19/20; G06T 19/006

(57) ABSTRACT

The present disclosure provides a method and system for providing delivery item information, in which a code including information for accessing information related to the item is attached to a package of the delivery item, and when the recipient captures the code attached to the package, the information related to the delivery item is output in an augmented reality so that the recipient can easily check the information related to the delivered item without removing the package. The recipient of the delivery item can grasp the information related to the delivery vividly without removing the package upon receipt of the delivery item and can promptly determine whether or not to receive the item upon receipt of the item.

### CROSS-REFERENCE TO RELATED APPLICATION

The present application claims priority to Korean Patent Application No. 10-2017-0085660 filed on Jul. 5, 2017, in the Korean Intellectual Property Office, which is incorporated herein in its entirety by reference.

### TECHNICAL FIELD

The present disclosure relates to a method and system for providing information related to a delivery item based on an augmented reality so that the information related to the delivery item can be checked in the augmented reality before a recipient of the delivery item removes the package.

### BACKGROUND

The description in this section merely provides background information of embodiments of the present disclosure and is not intended to specify prior arts of the present disclosure.

As non-face-to-face transactions such as Internet shopping and home shopping are increasing, delivery services such as a postal parcel service, courier, and air cargo service are also expanding.

According to current delivery services, the sender packs a delivery item in a paper box or plastic wrapping material to prevent the damage of the delivery item and attaches a waybill on an outer surface of a package, so that a carrier ships and delivers the delivery item package with reference to the waybill.

On the other hand, the delivered item remains in a state where it is difficult to check the content through the package even after the delivery is completed unless the packaging is removed. Thus, in case that the receiver of the delivery item is not the same as the orderer, the receiver may happen to receive an undesired item. Even when the orderer is identical to the recipient, the orderer does not know the condition of the item before the packaging is removed.

Meanwhile, with the development of the mobile communication network and the upgrading of the terminal specification, a mobile communication terminal has become a necessity of the modern people beyond the scope of a simple communication device or information providing device and is evolving to a total entertainment device.

For example, most of the mobile communication terminals are equipped with functionalities of recognizing codes for storing information such as barcodes and a QR code, and various application services utilizing such codes are expanding.

However, existing application services utilizing the code recognition capabilities do not go beyond a level that the address of a specific website is simply coded so that the user can easily access the website without inputting an exact address. In other words, the it may be said that the utilization of the code recognition capabilities is still very low.

In particularly, with regard to a delivery service, the codes are merely used for recording or inputting the information of the delivery item in terms of logistics management, and services for enhancing conveniences of the receiver or the sender is insignificant.

### SUMMARY

To solve the problems above, provided is a method and system for providing delivery item information, in which a code including information for accessing information related to the item is attached to a package of the delivery item, and when the recipient captures the code attached to the package, the information related to the delivery item is output in an augmented reality so that the recipient can easily check the information related to the delivered item without removing the package.

Also, provided is a method and system for providing delivery item information, in which the sender of the delivery item can easily transmit a message to the recipient using the code.

Additional aspects will be set forth in part in the description which follows and, in part, will be apparent from the description, or may be learned by practice of the presented exemplary embodiments.

According to an embodiment of the present disclosure, a method of providing information based on augmented reality in a device may include capturing, by using a camera of the device, an image of a package to which an information identification code is attached; recognizing the information identification code from the captured image of the package; accessing an information providing server based on the recognized information identification code to request information related to an delivery item contained in the package; receiving the requested information related to the delivery item from the information providing server; and combining the received information related to the delivery item with the captured image of the package to output in the augmented reality.

The information related to the delivery item may contain at least one of: an image, manufacture or production information, seller contact information, an instruction manual, a history, sender information, and recipient information of the delivery item, and a message sent by the sender to the recipient.

The operation of combining the information with the image of the package to output in the augmented reality may include: displaying the information related to the item by combining with the image of the package on a basis of a marker displayed on the image of the package.

The marker may be the information identification code or the image of the package.

The operation of combining the information with the image of the package to output in the augmented reality may include: changing at least one of a type, position, size, color, shape, orientation, and state of output information according to a position and orientation of the marker that change with a movement of the camera.

The message sent by the sender to the recipient may include at least one of: an image, a moving picture, a text, and a voice message.

The message sent by the sender to the recipient may be associated with a network-based communication service including at least one of: a social network service (SNS), an instant messenger service, an e-mail, a short message service (SMS), and a multimedia message service (MMS).

The operation of accessing the information providing server to request information related to the delivery item may include: acquiring recipient information, suitable for identifying the recipient, including at least one of: an IP address, a MAC address, and a mobile communication number assigned to the device, and a facial image and biometric information of the recipient; and transmitting acquired recipient information, to the information providing server for use in authenticating the recipient.

The method may include at least one of: capturing a facial image of the recipient by using the camera of the device as the recipient information; and recognizing a fingerprint of the recipient by using a fingerprint recognition sensor of the device as the recipient information.

The information identification code may be a matrix code including at least one of: a quick response (QR) code, a two-dimensional barcode, and a color barcode.

According to an embodiment of the present disclosure, a method of providing information based on augmented reality in an information providing server may include receiving a request for an augmented reality-based information service of a sender from one of a first terminal device, an electronic commerce server, and a delivery service server; acquiring and storing at least one information related to an item purchased or sent by the sender; generating an information identification code for accessing the information related to the item; transmitting the information identification code to any one of the first terminal device, the electronic commerce server, and the delivery service server; receiving an information request, from a second terminal device, using the information identification code; and transmitting the at least one information related to the item, to the second terminal device, corresponding to the information identification code in response to the information request.

The method may further include: receiving reference recipient information from one of the second terminal device, the electronic commerce server, and the delivery service server to store in a storage; receiving recipient information suitable for identifying the recipient, from the second terminal device, including at least one of: an IP address, a MAC address, and a mobile communication number assigned to the second terminal device, and a facial image and biometric information of the recipient; and performing authentication of the recipient by comparing the recipient information received from the second terminal device with the reference recipient information. When the authentication of the recipient is successful, the at least one information related to the item may be transmitted to the second terminal device.

According to an embodiment of the present disclosure, provided is a non-transitory computer-readable storage medium in which a program is stored. When executed by a processor, the program causes the processor to perform the method of providing information based on augmented reality.

According to an embodiment of the present disclosure, provided is a program stored in a non-transitory computer-readable storage medium. When executed by a processor, the program causes the processor to perform the method of providing information based on augmented reality.

According to an embodiment of the present disclosure, an information providing server includes: a communication unit configured to communicate with of a first terminal device, an electronic commerce server, and a delivery service server; a storage unit configured to store information related to an item provided by a sender; and an identification code generator configured to generate an information identification code for accessing the information related to the item; a controller configured to transmit the information identification code to one of the first terminal device, the electronic commerce server, and the delivery service server, receive an information request using the information identification code from a second terminal device, and transmit the information related to the item contained in a package corresponding to the information identification code to the second terminal device.

The storage unit may receive reference recipient information for the recipient to receive an augmented reality-based item information. The controller may compare information of the user receiving the package with the reference recipient information and transmits the at least one information related to the item contained in the package to the second terminal device only when the information of the user receiving the package coincides with the reference recipient information.

According to an embodiment of the present disclosure, a device may include a communication unit configured to communicate with an information providing server; a camera unit configured to capture an image of an information identification code and a facial image of a recipient; a biometric information recognition unit configured to recognize biometric information of the recipient; a controller configured to request information related to an item from the information providing server, receive the requested information, and combine the received information with an image of a package of the item to output in an augmented reality; and a storage unit configured to store the received information related to the item.

The controller may change at least one of a type, position, size, color, shape, orientation, and state of output information according to a position and orientation of a marker that change with a movement of the camera. The marker may be the information identification code or the image of the package.

According to the present disclosure, when a terminal equipped with a camera captures an identification code such as the QR code attached to the package of the delivery item, the information related to the delivery item is output with the photograph image of the package in the augmented reality, so that the recipient can easily check the information related to the delivered item without removing the package.

Also, the purchase or sender of the delivery item can easily transmit a message to the recipient using the code, so that the message may be displayed with the photograph image of the package in the augmented reality.

Further, various information related to the delivery item can be acquired in the terminal device of the recipient to be displayed in the augmented reality, so that the recipient can find the various information at the time of receiving the delivery item without opening the package of the delivery item.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a schematic block diagram of a system for providing delivery item information based on augmented reality according to an embodiment of the present disclosure;

FIG. 2 is a flowchart illustrating a method of providing delivery item information based on augmented reality associated with an electronic commerce service according to an embodiment of the present disclosure;

FIG. 3 is a flowchart illustrating a method of providing delivery item information based on augmented reality associated with a delivery service according to an embodiment of the present disclosure;

FIG. 4 is a block diagram of an information providing server according to an embodiment of the present disclosure;

FIG. 5 is a flowchart illustrating an operation of the information providing server according to an embodiment of the present disclosure;

FIG. 6 is a block diagram of a terminal device suitable for providing delivery item information based on augmented reality according to an embodiment of the present disclosure;

FIG. 7 is a flowchart illustrating an operation of the terminal device according to an embodiment of the present disclosure;

FIGS. 8A and 8B are exemplary screenshots for explaining a process of providing delivery item information based on augmented reality according to an embodiment of the present disclosure;

FIG. 8C is an exemplary table showing fields of a database maintained by the delivery service server; and

FIG. 9 is a block diagram illustrating an computing environment of a device for providing the delivery item information according to an embodiment of the present disclosure.

The drawings described herein are for illustration purposes only and are not intended to limit the scope of the present disclosure in any way.

### DETAILED DESCRIPTION

For a more clear understanding of the features and advantages of the present disclosure, the present disclosure will be described in detail with reference to the accompanied drawings.

In the following description and the accompanied drawings, detailed descriptions of well-known functions or configuration that may obscure the subject matter of the present disclosure will be omitted for simplicity. It is to be noted that the same components are designated by the same reference numerals throughout the drawings.

The terminologies including ordinal numbers such as “first” and “second” used to describe various elements in this specification may be used only to discriminate one element from another elements, but the terms do not restrict the structures of the elements.

It should be noted that the embodiments of the present disclosure described in the present specification and drawings are only illustrative of the present disclosure and are not intended to limit the scope of the present disclosure. It will be apparent to those skilled in the art that other modifications may be made based on the technical idea of the present disclosure in addition to the embodiments disclosed herein.

The terms and words used in the following description and drawings are not necessarily to be construed in an ordinary sense or a dictionary, and may be appropriately defined herein to be used as terms for describing the present disclosure in the best way possible. Such terms and words should be construed as meaning and concept consistent with the technical idea of the present disclosure.

When an element is referred to as being “connected” or “coupled” to another element, it means that it is logically or physically connected or it may be connected to the other element. In other words, it is to be understood that although an element may be directly connected or coupled to another element, there may be other elements therebetween, or element may be indirectly connected or coupled to the other element.

The terminology used herein is for the purpose of describing particular embodiments only and is not intended to be limiting of the disclosure. The singular forms include plural referents unless the context clearly dictates otherwise. Also, The expressions “˜comprises,” “˜includes,” “˜constructed,” “˜configured” are not to be construed as being equipped with all the components, processing steps, or operations described in this specification, but some of the components, the processing steps, or the operations may not be included and additional elements may be incorporated further.

The present disclosure enables a recipient of a delivery item to request information related to a delivery item by using an information identification code such as a quick response (QR) code, a barcode, a color code, and the like, and facilitates the recipient to check or find the information related to the delivery item in the augmented reality even when the package is not removed.

Preferably, the terminal device is an information processing device of a type that can be carried by a user and is capable of wireless communications and equipped with the camera. However, terminal device is not limited thereto but may be one of various terminals such as a smartphone, a portable terminal, a mobile terminal, a personal digital assistant (PDA), a portable multimedia player (PMP) terminal, a telematics terminal, a navigation terminal, a personal computer (PC), a notebook computer, a slate PC, a tablet PC, an ultrabook, a wearable device such as a smart watch and a smart glass, a head-mounted display (HMD), a Wibro terminal, an Internet Protocol television (IPTV) terminal, a smart TV, a digital broadcast receiver terminal, an audio-video navigation (AVN) terminal, an audio/video (AN) system, and a flexible terminal.

Even though it is impossible to enumerate all types of the terminal device considering the convergence trend of digital devices, any device unit equivalent to the device units mentioned above may be used as the terminal device. Also, any device unit capable of communicating with the information providing server through the network may be used as the terminal device according to the present disclosure. In addition, the terminal device may be a device currently available as well as any other device that may be developed in the future and has a communications capability. Although just two terminal devices are shown in the drawings, there may be more terminal devices, in the system, that communicate with the information providing server.

According to embodiments of the present disclosure, the terminal device can be divided into a terminal device of a sender and a terminal device of a recipient according to its user. However, the terminal device of the sender may be the same as the terminal device of the recipient from a viewpoint of hardware, and the specific terminal device may operate as the terminal device of the sender or the recipient depending on the role of the user in the information providing service according to the present disclosure.

Hereinbelow, described are a system and method of providing delivery item information based on augmented reality according to an embodiment of the present disclosure with reference to the attached drawings.

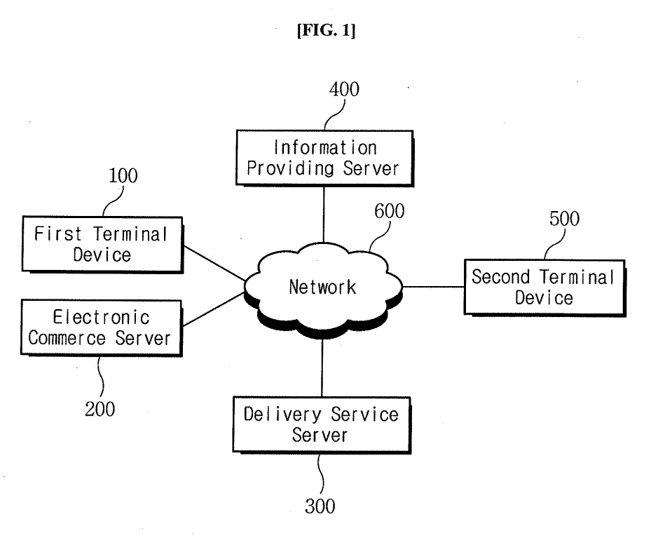

FIG. 1 is a schematic block diagram of an information providing system based on augmented reality according to an embodiment of the present disclosure. The information providing system shown in FIG. 1 includes a first terminal device 100, an electronic commerce server 200, a delivery service server 300, an information providing server 400 and a second terminal device 500 connected through a network 600.

The network 600 enables data transmission among the devices mentioned above such as the first terminal device 100, the electronic commerce server 200, the delivery service server 300, the information providing server 400, and the second terminal device 500. The type of network 600 is not limited to any particular one.

For example, the network 600 may include a wireless network such as a wireless local area network (WLAN), a Wi-Fi network, a wireless broadband Internet (Wibro) network, a Worldwide Interoperability for Microwave Access (WiMAX) network, and a High Speed Downlink Packet Access (HSDPA) network. However, the present disclosure is not limited thereto, but the network 600 may include a wired network such as Ethernet, Digital Subscriber Line (xDSL) such as a Asymmetric Digital Subscriber Line (ADSL) or a Very High Bitrate Digital Subscriber Line (VDSL) network, a Hybrid Fiber Coaxial Cable (HFC) network, a Fiber-to-the-Curb (FTTC) network, and a fiber-to-the-home (FTTH) network.

Also, the network 600 may include a mobile communication network comprised of a plurality of access networks (not shown) and a core network (not shown) connecting the plurality of access networks. The access networks, which allow the terminal devices to be connected to the core network for wireless communications, may include a plurality of base stations such as a traditional base station (BS), a base transceiver station (BTS), a Node B (NodeB), an Evolved Node B (eNodeB), and a plurality of base station controllers such as a traditional Base Station Controller (BSC) and a Radio Network Controller (RNC). Meanwhile, a digital signal processing unit and a radio signal processing unit which may be integrally implemented in the base station may be reorganized into a digital unit (DU) and a radio unit (RU), so that each of a plurality of the RUs are provided in respective one of a plurality of areas, and the plurality of RUs are connected to a centralized DU.

The core network, which performs main functions for mobile communication services such as mobility control and switching among terminal devices, performs circuit switching or packet switching operations, and manages and controls packet flow in the mobile communication network. Also, the core network manages inter-frequency mobility and may play a role for interworking traffics in the access network and the core network with another network such as Internet. The core network may further include at least one of: a Serving Gateway (SGW), a Packet Data Network (PDN) Gateway, a Mobile Switching Center (MSC), a Home Location Register (HLR), a Mobile Management (MME), and a Home Subscriber Server (HSS).

Also, the network 600 according to the present disclosure may include the Internet. The Internet refers to a open network or a public network that allows information exchange according to a TCP/IP protocol.

first terminal device 100, the electronic commerce server 200, the delivery service server 300, the information providing server 400, and the second terminal device 500 may interoperate with each other through the network 600 to provide the service of providing the information providing service based on the augmented reality of the present disclosure.

The first terminal device 100 may be a terminal used by a sender requesting the delivery of an item. The sender may be a purchaser who has purchased the item through an electronic commerce service or a delivery service user who has requested the delivery of the item through a delivery service. In case that the sender is a buyer, the first terminal device 100 may access the electronic commerce server 200 to carry out a purchasing process according to an operation of the buyer, and request an augmented reality-based information providing service for the delivery item. In case that the sender is an orderer of the delivery service, the first terminal device 100 may access the delivery service server 300 to request the delivery of item according to the operation of the orderer, and request the augmented reality-based information providing service for the delivery item. The request for the augmented reality-based information service from the first terminal device 100 may be directly transmitted to the information providing server 400 or may be forwarded to the information providing server 400 through the electronic commerce server 200 or the delivery service server 300.

In addition, the first terminal device 100 may provide the information providing server 400 with details of the information to be provided based on the augmented reality in addition to the request for the augmented reality-based information providing service. To this end, the first terminal device 100 may receive a list of the information that can be provided based on the augmented reality from the information providing server 400, and may select one of the available information from the list and provide selection information the information providing server 400.

The order from the first terminal device 100 may be processed according to a prescribed procedure in the electronic commerce server 200, and the ordered item may be delivered to a recipient designated by the purchaser. Similarly, the order for the delivery service from the first terminal device 100 may be processed according to a prescribed procedure, and the ordered item may be delivered to a recipient designated by the orderer. The recipient of the item may the purchaser, or a third party who is not the purchaser or the orderer.

The electronic commerce server 200 is a device of a commerce service provider who operates an open market suitable for mediating transactions between sellers and consumers, an online shopping mall constructed by a seller, or a social commerce service allowing collaborative purchases based on the communication network 300. The service server 200 may distribute an application program suitable for use in the electronic commerce service, so that the first terminal device 100 can install and execute the application program to provide the electronic commerce service to the user through a cooperation with the electronic commerce server 200.

The application program may be suitable for a product purchasing process, which may include a search, selection, order, and payment for an item.

The electronic commerce server 200 can support the augmented reality-based information providing service provided by the information providing server 400. Specifically, the electronic commerce server 200 may provide the information providing server 400 with the request for the augmented reality-based information providing service from the first terminal device 100, and provides the first terminal device 100 or the information providing server 400 with the information about the item maintained by the electronic commerce server 200. Also, the electronic commerce server 200 may provide an information identification code corresponding to the item information generated by the information providing server 400 to a delivery relevant entity such as the purchaser, seller, and a shipper, so that the entity attach the information identification code on a package of the delivery item.

The information related to the item may include at least one of: an image of the item, a history of the item, a size of the item, a color of the item, production information of the item, a material of the item, and an instruction manual of the item.

The delivery service server 300, which is a device of a delivery service provider, may receive a delivery service order through the network 600, receive sender information and recipient information for delivery, and performs a necessary payment process. The delivery service provider may pick up the item from the sender according to the information received through the delivery service server 300 and delivers the item to the designated recipient.

The delivery service server 300 can support the augmented reality-based information providing service according to the present disclosure similarly to the electronic commerce server 200. For example, the delivery service server 300 can receive information to be provided in the augmented reality from the first terminal device 100 or the electronic commerce server 200 to provide to the information providing server 400, and receive the information identification code generated by the information providing server 400 to distribute the information to the recipient when the item is delivered.

The information providing server 400, which provides the augmented reality-based information providing service according to an embodiment of the present disclosure, performs a collection of information to be provided in the augmented reality, a generation and distribution of information identification code corresponding to the information provided in the augmented reality, and providing the augmented reality-based information using the information identification code.

To this end, the information providing server 400 may be interfaced with one or more of the first terminal device 100, the electronic commerce server 200, the delivery service server 300, and the second terminal device 500.

The information providing server 400 receives the request for the augmented reality-based information providing service from one of the first terminal 100, the electronic commerce server 200, and the delivery service server 300, and receives the information related to the item to be provided in the augmented reality. The information related to the item may include at least one of: the image of the item, manufacture or production information of the item, seller contact information, the instruction manual of the item, the history information of the item, the sender or the item, the purchaser of the item, and a message sent by the sender of the item to the recipient of the item. The information related to the item may be collected from a device other than the first terminal device 100, the electronic commerce server 200, or the delivery service server 300.

The information providing server 400 generates the information identification code corresponding to the collected information related to the item and distribute the information related to the item by transmitting the information identification code to the first terminal device 100, the electronic commerce server 200, or the delivery service server 300 who may be a subject responsible for the delivery of the item. The information identification code may include encoded information of the item information or encoded information of a universal resource locator (URL) of a device that stores the information related to the item, and may be used to acquire the information related to the item.

The information identification code may be printed in a form of a conventional waybill to be attached to the delivery item (i.e., the package of the delivery item) before being shipped and delivered to the recipient.

The information providing server 400 may receive an information request which may be submitted using the information identification code from the second terminal device 500 and provide the information related to the item corresponding to the information identification code to the second terminal device 500.

The second terminal device 500 is a client receiving the augmented reality-based information according to the present disclosure. Here, the user who receives the information may be the recipient of the delivery item. The second terminal device 500 operates as follows according to the operation of the recipient.

The second terminal device 500 can execute an application program which supports the augmented reality-based information providing service by communicating and cooperating with the information providing server 400 through the network 600. Upon execution of the application program, the second terminal device 500 may activate a built-in camera and capture a photograph of the identification code attached to the delivery item through the camera. Here, the delivery item refers to an item delivered by courier or mail service and generally is packaged in a paper box or plastic package. The recipient cannot check the content of the package unless the recipient removes the package, but it is difficult to return the item to cancel the order once the package is removed. According to the present disclosure, in order to allow checking information about the delivery item before the packaging is removed, the information identification code generated in association with the information about delivery item is attached to the delivery item package. The second terminal device 500 may capture the photograph of the information identification code attached to the delivery item, extracts and recognizes the information identification code included in the photograph, and request the information about the delivery item by use of the information identification code from the information providing server 400 to receive the information.

The information identification code may be a simple one-dimensional barcode, a two-dimensional barcode such as a QR code, a color bar code, or any other variant of them. Each of the codes may include a combination of figures, of which visual characteristics such as a pattern, thickness of each bar, and a combination of colors store various information. The information identification code may include any one of the various types of codes that may be available in the future in addition to the codes currently being used or proposed already.

In a preferred embodiment of the present disclosure, the two-dimensional barcode such as the QR code may be used for the information identification code. The QR code, for example, is a type of matrix barcode consisting of back squares arranged in a square grid on a white background, and may store up to 7,089 numeric characters, 4,296 alphanumeric characters, or 1,817 Kanji characters. Because of the large amount of data that can be stored, the QR code has an advantage of being able to store Internet universal resource locator (URL), still image and moving picture, map, and business card information, and is widely being used as an advertisement or marketing tool in addition to a traditional usage of product identification in a store or a factory. According to the present disclosure generates, the two-dimensional barcode is generated to contain the information related to the item or the address (URL) for accessing the information related to the item. The information identification code may be generated and distributed by the information providing server 400 and be attached to the item for the delivery.

Thus, the second terminal device 500 may decode the information identification code to acquire the information related to the item directly from the information identification code or to extract the address for accessing the information related to the item. When the address is extracted from the information identification code, the second terminal device 500 may request the information related to the item from the information providing server 400 to acquire the information.

The information related to the item may include any information as long as it can be provided to and useful to the recipient regarding the delivery item. For example, the information related to the item may include information directly related with the delivery item such as the instruction manual of the delivery item, the image of the delivery item, the manufacture or production information of the delivery item, the seller contact information of the delivery item, and the history information of the delivery item as well as an advertisement of the delivery item, a corporate advertisement of the manufacturer, various marketing information, and the message sent by the sender of the item to the recipient of the item as mentioned above.

Upon receiving the information related to the item from the information providing server 400, the second terminal device 500 may combine the received information related to the item with an image (i.e. an actual photograph) captured by the camera to output in the augmented reality. That is, the second terminal device 500 may output the information related to the item corresponding to the information identification code in a form of the augmented reality by combining with the real photograph being captured by the camera, so that the user of the second terminal device 500 can acquire vivid information about the delivery item and check the content of the delivery item easily even without removing the package of the delivery item. At this time, as the user of the second terminal device 500 moves, the information displayed in the augmented reality may change according to the movement of the second terminal device 500, which may enhance the vividness of the information.

In addition, when the information related to the item includes private information such as the message of the sender, it is desirable that only a legitimate recipient can view the information related to the item. In such a case, the second terminal device 500 may extract user information (e.g. a device identification number, a mobile phone number, a user ID, and the like) that may be used to identify the user of the second terminal device 500 and send extracted information to the information providing server 400.

The information providing server 400 may compare the user information received from the second terminal device 500 having requested the item information with recipient information registered previously to check whether the user of the second terminal device 500 is the legitimate recipient of the delivery item and determine whether to provide the information related to the item to the second terminal device 500 according to a checking result.

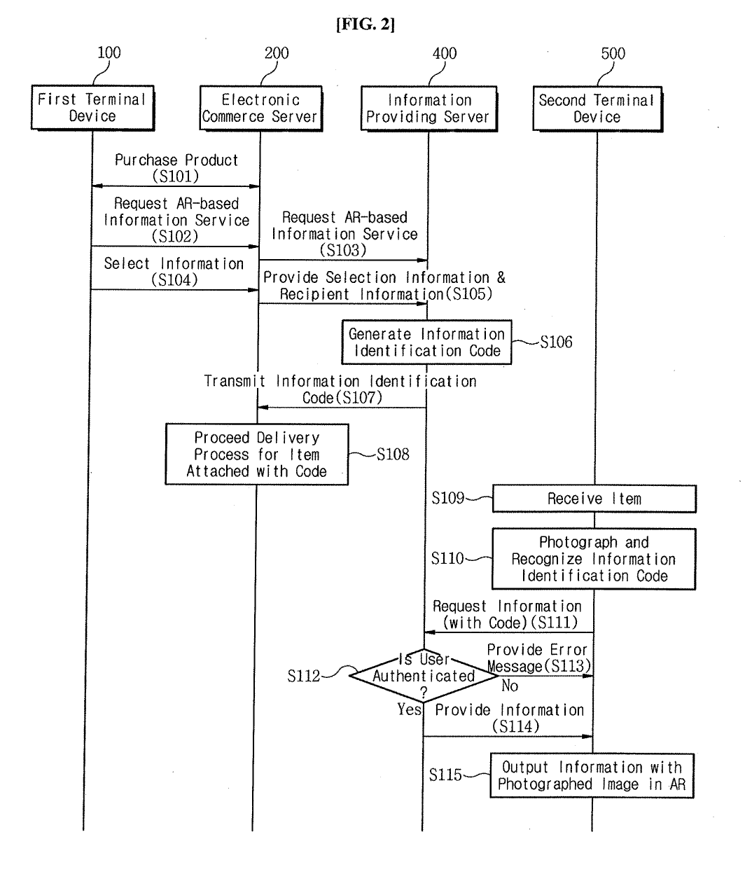

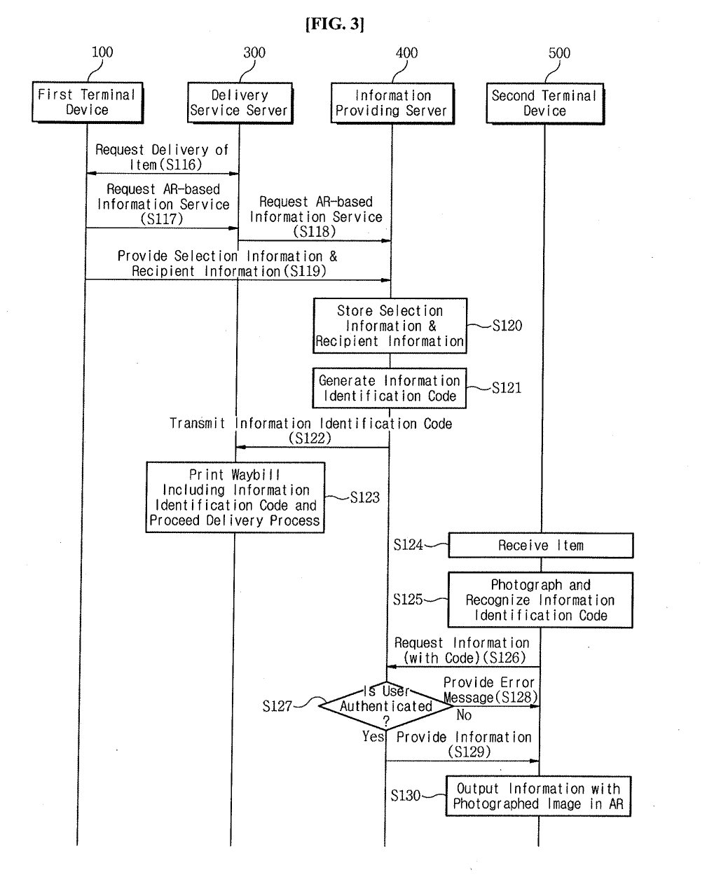

The operation of the information providing system configured as described above will now be described with reference to FIGS. 2 and 3.

FIG. 2 is a flowchart illustrating a process of providing information based on the augmented reality in association with an electronic commerce service according to an embodiment of the present disclosure.

Referring to FIG. 2, a user (hereinafter, referred to as “purchaser”) of the electronic commerce service may access the electronic commerce server 200 by using the first terminal device 100 to select and purchase a certain product among the products sold by the electronic commerce server 200.

At this time, a prescribed purchasing procedure including selection and ordering of an item and payment for the item is carried out between the first terminal device 100 and the electronic commerce server 200 (S101). Since details of the purchasing procedure is well known in the art, a detailed description thereof will be omitted for simplicity.

During the purchasing procedure, the purchaser may request the augmented reality-based information service (S102). The request for the augmented reality-based information service may be transmitted to the information providing server 400 through the electronic commerce server 200 (S103).

At this time, the request for the augmented reality-based information service may be submitted by the purchaser so that the recipient of the ordered item may receive the information related with the ordered item. Alternatively, however, the request for the augmented reality-based information service may be submitted by a seller of the ordered item or a provider of the electronic commerce service rather than the purchaser.

Further, the purchaser may select information to be provided in the augmented reality through the first terminal device 100. In such a case, selection information may be transmitted to the information providing server 400 through the electronic commerce server 200 (S104, S105). During this course, the purchaser may input purchaser information and recipient information. The information to be provided in the augmented reality may include the information related with the delivery item and/or purchaser and the recipient such as a name of the item, the image of the item, the recipient of the item, the history of the item, the instruction manual of the item, and the message.

The information providing server 400 generates the information identification code based on the information received from the first terminal device 100 (S106). Specifically, the information providing server 400 may store the received information and generate the information identification code to include the item information itself or the address (URL) for accessing the device storing the item information.

The information providing server 400 provides the information identification code generated in the operation S106 to the electronic commerce server 200 (S107).

Here, the information identification code stores information by a combination of the pattern, the thickness, and any of the known codes can be used for the information identification code. In an embodiment, the information identification code may be a QR code. However, the present disclosure is not limited thereto, and any code that may accommodate information and is commercially available or will be available in the future may be used for the information identification code as well regardless of the type of the code such as one-dimensional, two-dimensional, and three-dimensional codes.

Meanwhile, the operation S107 is carried out to distribute the information identification code so that the information identification code can be attached to the delivery item. Since the service provider of the electronic commerce service may control or manage the delivery of the ordered item in the embodiment of FIG. 2, the information identification code is provided to the electronic commerce server 200.

Accordingly, the electronic commerce server 200 carries out information processing necessary for attaching the information identification code received from the information providing server 400 to the ordered item and delivering the ordered item attached with the information identification code to the recipient according to a prescribed delivery procedure (S108). For example, in case that the seller is responsible for the delivery, the electronic commerce server 200 transmits the information identification code to the seller, so that the seller can print the information identification code to attach to the item and then ship the item. In case that the service provider of the electronic commerce service is responsible for the delivery, the electronic commerce server 200 may make a delivery person to print the information identification code and attach a printed code to the item. Since the details of the delivery procedure is irrelevant of the information providing service according to the present disclosure, and a detailed description thereof will be omitted for simplicity.

The information identification code may be printed on the waybill. However, the information identification code may be printed along with the waybill in a form of a separate sticker.

The item to which the information identification code is attached through the above process may be delivered to the recipient. Afterwards, the information related to the item may be provided based on the augmented reality to the second terminal device 500 carried by the recipient through interactions of the second terminal device 500 with the information terminal 400.

In detail, when the recipient receives the delivery item (S109) and wants to receive information related to the delivery item, the recipient may activate the camera of the second terminal device 500 to capture a photograph of the information identification code attached to the item and recognize the information identification code (S110). The recognition of the information identification code refers to a process of decoding the information identification code to convert into digital data or information text. In the present embodiment, it is assumed that the information identification code includes the address for accessing the item information to be provided in the augmented reality.

Subsequently, the second terminal device 500 may request the information related to the item from the information providing server 400 by use of the address information extracted from the information identification code in the operation S110 (S111).

Meanwhile, the augmented reality-based information service can be provided only to the legitimate recipient designated by the sender for protecting the privacy of the recipient. To this end, the second terminal device 500 may transmit the information suitable for identifying the user of the second terminal device 500 (Hereinafter, referred to as “user information”) while requesting the information related to the item from the information providing server 400.

Also, in order to capture the photograph of the information identification code and recognize the information identification code in the operation S110, the second terminal device 500 may install and execute an application program suitable for activating the camera, taking the photograph of the information identification code, and recognizing the information identification code to access the information providing server 400.

The photographing of the information identification code may include a process of aligning the second terminal device 500 such that the information identification code is positioned within a predetermined frame of the camera and a process of pressing a shooting button of the camera. At this time, a separate guide mark may be displayed on the activated camera to facilitate positioning of the identification code within the frame of the camera, and the user may move the second terminal device 500 in such a direction that the identification code enters the frame following the guide mark.

In case that the information identification code recognized in step S110 includes the information related to the item rather than the address for accessing the information related to the item, the second terminal device 500 need not perform the request for the information related to the item in the operation S111, but may directly perform an operation S115 to output the extracted information related to the item in the augmented reality or transmit only the use information, without requesting the information related to the item in the operation S111, to request an user authentication to verify that the user of the second terminal device 500 is the legitimate recipient of the delivery item.

After the operation S111, the information providing server 400 may perform the user authentication to verify that the user of the second terminal device 500 is the legitimate recipient of the delivery item, so that the augmented reality-based information service is provided only to the legitimate recipient (S112). In the user authentication, the user information received from the second terminal device 500 is compared with the recipient information designated by the sender, and the user of the second terminal device 500 is determined to be the legitimate recipient when the user information is identical to the recipient information designated by the sender.

When it is determined in the operation S112 that the user information received from the second terminal device 500 is identical to the recipient information designated by the sender, the information providing server 400 provides the second terminal device 500 with the information related to the item stored in the device corresponding to the address information (S114). Contrarily, when the user information is not identical to the recipient information, the information providing server 400 may provide the second terminal device 500 with an error message informing that the information cannot be provided because the user is not the legitimate recipient (S113).

Upon receiving the information related to the item in the operation S114, the second terminal device 500 may combine the information related to the item received in the operation S114 with the real photograph image being captured by the camera to output in the augmented reality (S115).

On the other hand, in the case that the user authentication is not necessary, the information providing server 400 may perform the operation step S114, while skipping the operations S112 and S113, to provide the information related to the item corresponding to the address information immediately to the second terminal device 500.

When the sender wants to send a personal message to the recipient or wants the information of the delivery item not to be exposed to a third party, the information providing server 400 may limitedly provide the information of the delivery item only to the designated recipient through the user authentication process, and thus can safely transmit the information of the delivery item to the recipient while satisfying the requirement of the user.

In addition, the user authentication may be performed by receiving a unique information of the second terminal device 500 such as an Internet protocol (IP) address, a medium access control (MAC) address, and the mobile phone number or user identification information that can be used to identify the user, such as the facial image or biometric information of the user and comparing received information with corresponding information registered to the information providing server 400 or the electronic commerce server 300 in advance.

As described above, according to the embodiment of the present disclosure, the recipient of the delivery item can request the information of the delivery item simply and easily by capturing the package of the delivery item without opening the package. Furthermore, since the information of the delivery item is provided in the augmented reality along with the captured image of the delivery item package, the recipient can intuitively check the information of the delivery item.

In particular, the recipient can vividly view the message of the sender who sent the delivery item since the message may be output in the augmented reality with the image of the delivery item package.

FIG. 3 is a flowchart illustrating a process of providing information based on the augmented reality in association with a delivery service according to an embodiment of the present disclosure.

Referring to FIG. 3, a service user of the delivery service may request the delivery of an item and the augmented reality-based information service from the delivery service server 300 by using the first terminal device 100 (S116, S117). The delivery of the item may be accomplished according to a prescribed delivery service procedure.

Upon receiving the request for the delivery of the item and the augmented reality-based information service, the delivery service server 300 may forward the request for the augmented reality-based information service to the information providing server 400 (S118).

At this time, the request for the augmented reality-based information service may be submitted by the sender of the delivery item or the delivery service server 300.

Further, the sender may select information to be provided in the augmented reality through the first terminal device 100. In such a case, the selection information may be transmitted to the information providing server 400 (S119). During this course, the sender may input sender information and recipient information. The information to be provided in the augmented reality may include at least one of: the image of the item, the recipient of the item, the history of the item, the instruction manual of the item, and the message of the sender.

The information providing server 400 generates the information identification code based on the information received from the first terminal device 100 (S121). Specifically, the information providing server 400 may store the received information and generate the information identification code to include the received information itself or the address (URL) for accessing the device storing the received information.

The information providing server 400 provides the information identification code generated in the operation S106 to delivery service server 300 (S122).

Meanwhile, the operation S122 is carried out to distribute the information identification code so that the information identification code can be attached to the delivery item.

Here, the information identification code stores information by a combination of the pattern, the thickness, and any of the known codes can be used for the information identification code. In an embodiment, the information identification code may be a QR code. However, the present disclosure is not limited thereto, and any code that may accommodate information and is commercially available or will be available in the future may be used for the information identification code as well regardless of the type of the code such as one-dimensional, two-dimensional, and three-dimensional codes.

Afterwards, the delivery service server 300 may allow a print-out of a waybill containing the information identification code and performs a delivery process for the item (S123).

For example, in case that a shipping and delivery company is responsible for the delivery, the delivery service server 300 may transmit the information identification code to the shipping and delivery company, so that the shipping and delivery company can print the information identification code to attach to the item and then ship the item.

The information identification code may be printed on the waybill. However, the information identification code may be printed along with the waybill in a form of a separate sticker.

In the present embodiment, the information identification code may be provided to the first terminal device 10 so that the sender may print the information identification code and attach the information identification code to the package of the delivery item contrary to the embodiment described above with reference to FIG. 2.

On the other hand, the recipient of the delivery item may acquire the information of the delivery item by use of the information identification code as follows.

When the recipient receives the delivery item (S124) and wants to receive information related to the delivery item, the recipient may activate the camera of the second terminal device 500 to capture a photograph of the information identification code attached to the item and recognize the information identification code (S125).

The second terminal device 500 may request the information related to the delivery item from the information providing server 400 by use of the information identification code (S126). The process of capturing the information identification code and requesting the information may be performed using the application program.

Meanwhile, the augmented reality-based information service can be provided only to the legitimate recipient designated by the sender for protecting the privacy of the recipient. To this end, the second terminal device 500 may transmit the information suitable for identifying the user of the second terminal device 500 while requesting the information related to the item from the information providing server 400.

Also, in order to capture the photograph of the information identification code and recognize the information identification code in the operation S125, the second terminal device 500 may install and execute an application program suitable for activating the camera, taking the photograph of the information identification code, and recognizing the information identification code to access the information providing server 400.

The photographing of the information identification code may include the process of aligning the second terminal device 500 such that the information identification code is positioned within the predetermined frame of the camera and the process of pressing the shooting button of the camera. At this time, the separate guide mark may be displayed on the activated camera to facilitate positioning of the identification code within the frame of the camera, and the user may move the second terminal device 500 in such a direction that the identification code enters the frame following the guide mark.

In case that the information identification code recognized in step S125 includes the item information rather than the address for accessing the item information, the second terminal device 500 need not perform the request for the information related to the item in the operation S126, but may directly perform an operation S131 to output the extracted item information in the augmented reality or transmit only the use information, without requesting the information related to the item in the operation S126, to request an user authentication to verify that the user of the second terminal device 500 is the legitimate recipient of the delivery item.

After the operation S126, the information providing server 400 may perform the user authentication to verify that the user of the second terminal device 500 is the legitimate recipient of the delivery item, so that the augmented reality-based information service is provided only to the legitimate recipient (S127). When it is determined in the operation S127 that the user information received from the second terminal device 500 is identical to the recipient information designated by the sender, the information providing server 400 provides the second terminal device 500 with the item information stored in the device corresponding to the address information (S129). Contrarily, when the user information is not identical to the recipient information, the information providing server 400 may provide the second terminal device 500 with an error message informing that the information cannot be provided because the user is not the legitimate recipient (S128).

Upon receiving the information related to the item in the operation S129, the second terminal device 500 may combine the item information received in the operation S129 with the real photograph image being captured by the camera to output in the augmented reality (S130).

When the sender wants to send a personal message to the recipient or wants the information of the delivery item not to be exposed to a third party, the information providing server 400 may limitedly provide the information of the delivery item only to the designated recipient through the user authentication process, and thus can safely transmit the information of the delivery item to the recipient while satisfying the requirement of the user.

The authentication of the recipient may be performed by, for example, executing the application program to activate a front camera of the second terminal device 500, capturing the photograph of the face of the user by the front camera, and comparing whether the photograph of the face of the user is identical to the face image of the recipient registered in advance. Also, the authentication of the recipient may be performed by comparing the biometric information of the user such as iris recognition information and fingerprint information with corresponding information of the recipient registered in advance. Further, the authentication of the recipient may be performed by comparing the IP address or the MAC address assigned to the second terminal device 500 or the mobile phone number of the second terminal device 500 with corresponding information of the recipient registered in advance.

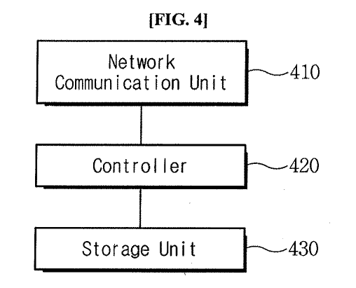

FIG. 4 is a block diagram of the information providing server 400 according to an embodiment of the present disclosure.

Referring to FIG. 4. the information providing server 400 may include a network communication unit 410, a controller 420, and a storage unit 430. FIG. 4 illustrates basic components of the information providing server 400 according to an embodiment, but the information providing server 400 may include additional components other than those shown in FIG. 4. The network communication unit 410, the controller 420, and the storage unit 430 may be implemented by computer software, firmware, or hardware, or a combination of one or more of them.

The network communication unit 410 enables the information providing server 400 to communicate with the first and second terminal devices 100 and 500, the electronic commerce server 200, and the delivery service server 300. The network communication unit 410 may interwork with an interface server of a delivery service system, for example, to support transmission and reception of information necessary for the service of providing the information related to the delivery item according to the present information.

The controller 430 controls overall operation of the information providing server 400, and may include an operating system and a processor device configured to generate and manage the information identification code. The information identification code may be generated for each delivery item. Alternatively, however, the information identification code may be generated for each type of delivery item, for each recipient, or for other criteria.

Also, the controller 430 may receive the request for the delivery item related information along with the information identification code from the second terminal device 500 and provide the second terminal apparatus 500 with the information related to the delivery item corresponding to the information identification code.

The controller 430 may compare the user information of the second terminal apparatus 500 with the recipient information provided by the sender, and provide the information related to the delivery item only when the two information matches each other.

The user information may be provided by the second terminal apparatus 500 having accessed the information providing server 400 by use of the information identification code, and may be any one of the IP address or the MAC address assigned to the second terminal device 500, the mobile phone number of the second terminal device 500, the facial image of the user, and the biometric information of the user.

The storage unit 430 stores information related to the delivery item provided by the sender and all the programs for providing the information service of the present disclosure. The information related to the delivery item may include at least one of: the image of the item, the history of the item, the instruction manual of the item, the recipient of the item, and the message of the sender.

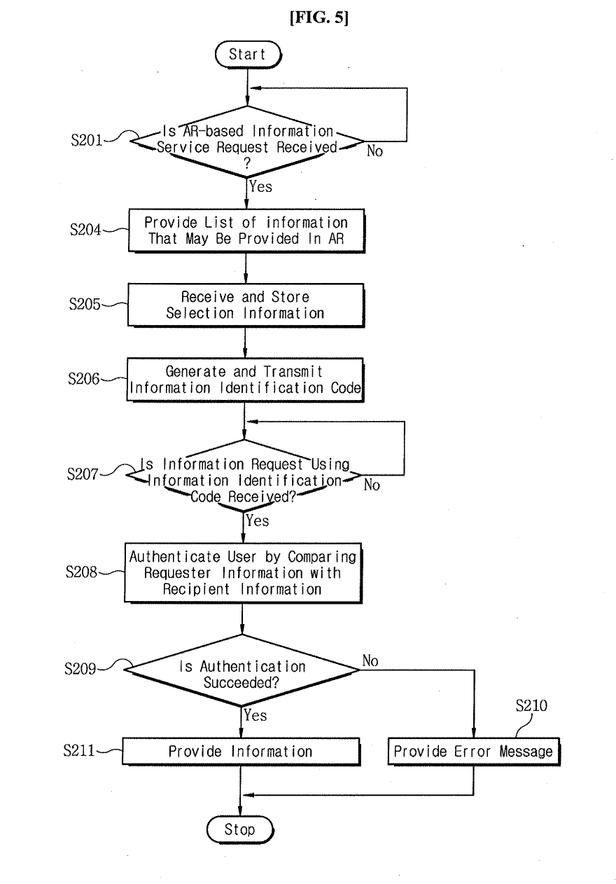

FIG. 5 is a flowchart illustrating an operation of the information providing server 400 according to an embodiment of the present disclosure.

The augmented reality-based information providing service according to the present disclosure is provided by the information providing server 400 through the interworking with the electronic commerce server 200 and/or the delivery service server 300 and can be more easily understood through the operation of the information providing server 400, which is described below.

Referring to FIG. 5, the information providing server 400 may receive the request for the augmented reality based information providing service from the first terminal device 100, the electronic commerce server 200, or the delivery service server 300 (S201).

To perform the requested augmented reality-based information providing service, information to be provided in the augmented reality, that is, information related to the product item is required. The information providing server 400 can acquire the information related to the item that may be provided in the augmented reality by cooperating with the electronic commerce server 200 or the delivery service server 300, and other server devices. For example, the information providing server 400 can receive the information related to the item from the electronic commerce server 200, the delivery service server 300, or other server devices to generate a list of information that can be provided in the augmented reality. As mentioned above, some of the information may be provided by the first terminal device 100.

The information providing server 400 may provide the first terminal device 100, the electronic commerce server 200, or the delivery service server 300 with the list of information that can be provided in the augmented reality (S204), and receives the selection information indicating which information was selected from the list by the first terminal device 100, the electronic commerce server 200, or the delivery service server 300 (S205). In addition, the information providing server 400 may interface with the electronic commerce server 200 or the delivery service server 300, and the other server devices to provide the list of the information.

The information that can be provided in the augmented reality includes all the information related to the production, distribution and use of the item including the image of the item and the history of the item. Also, such information may include information related to shipping and delivery such as the recipient information and the sender message.

After receiving and storing the selection information for the item information to be provided in the augmented reality, the information providing server 400 may generate the information identification code based on the selection information and the item information, and provides the generated information identification code to a device in charge of the delivery of the item such as the electronic commerce server 200 and the delivery service server 300 (S206). The electronic commerce server 200 may provide the received information identification code to the seller according to a predetermined delivery procedure or the delivery service server 300.

The seller, the delivery service company, or the electronic commerce service provider having received the information identification code may print the information identification code in the form of a printed matter to attach the printed information identification code to the package of the item.

After distributing the information identification code as described above, the information providing server 400 may wait for the request for the information related to the item using the information identification code.

When the recipient having received the delivery item captures the photograph image of the information identification code attached to the delivered item using the second terminal device 500 and request the information related to the item by using the information extracted from the information identification code (S207), the information providing server 400 may perform the authentication of the user to determine whether the user of the second terminal device 500 is the legitimate recipient by comparing the user identification information received from the second terminal device 500 with the recipient information registered in advance (S208). The second terminal device 500 may transmit the user identification information to the information providing server 400 together with the information request or may transmit the user identification information to the information providing server 400 in response to a request of the information providing server 400.

In the operation S208, the information providing server 400 can receive the mobile phone number, for example, from the second terminal device 500 to check whether the mobile phone number is registered previously as the number of the legitimate recipient. In another embodiment, the second terminal device 500 may activate the camera to capture the facial image of the user the second terminal device 500 and transmit the captured facial image of the user to the information providing server 400 in a state that the information providing server 400 has the facial image of the recipient stored therein, The information providing server 400 can determine whether the user of the information providing server 400 is the legitimate recipient of the item by extracting characteristic feature information of the received facial image and comparing the characteristic information with that of the facial image of the legitimate recipient previously stored in the information providing server 400.

Besides, information providing server 400 can use the biometric information such as fingerprint, vein, iris, and voice information to authenticate the user of the second terminal device 500.

The authentication of the operation S208 may be performed by the second terminal device 500 after the information providing server 400 provides the second terminal device 500 with the identification information of the legitimate recipient. In such a case, the authentication process is similar to the process described above except that the subject performing the authentication process is changed.

The legitimate recipient may be the purchaser having ordered the item through the electronic commerce service or the recipient designated by the purchaser or the sender who requested the delivery of the item.

If the user of the second terminal device 500 is determined to be the legitimate recipient (S209), the information providing server 400 provides second terminal device 500 with the information related to the item corresponding to the information identification code recognized by the second terminal apparatus 500 (S211). If, however, it is determined that the user of the second terminal device 500 is not the legitimate recipient, the information providing server 400 provides the second terminal device 500 with the error message informing that the information cannot be provided (S210).

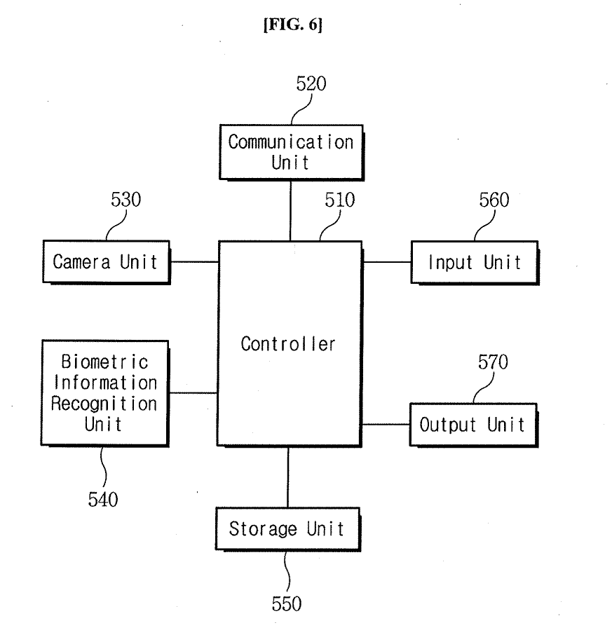

FIG. 6 is a block diagram of the first and second terminal devices 100 and 500 according to an embodiment of the present disclosure.

Referring to FIG. 6, each of the terminal devices may include a controller 510, a communication unit 520, a camera unit 530, a biometric information recognition unit 540, a storage unit 550, an input unit 560, and an output unit 570.

FIG. 6 illustrates basic components of the first and second terminal devices 100 and 500 according to an embodiment, the first and second terminal devices 100 and 500 may include additional components other than those shown in FIG. 6.

The communications unit 530 transmits and receives data to and from another devices through the network 600. In particular, the communications unit 530 communicates with the information providing server 400 through the network 600 to transmit the recognition result of the information identification code or the photographed image of the item, and decoded or analyzed information to the information providing server 400. The communications unit 530 may transmit and receive other data needed for the augmented-reality-based information service according to the present disclosure.

The communications unit 520 may include at least one of a wireless communication module (not shown) and a wired communication module (not shown).

The wireless communication module, which enables the data transmission through the network adopting the wireless communication scheme, may include at least one of a mobile communication module, a wireless LAN communication module, and a wireless personal area network (PAN) so that the first and second terminal devices 100 and 500 may transmit and receive data to and from the electronic commerce server 200 and the information providing server 400 through at least one of such modules.

The wired communication module, which enables the data transmission through a wired channel, may access the network 600 through the wired channel to transmit and receive data to and from the electronic commerce server 200 and the information providing server 400.

The controller 510 may be a processor device which executes the operating system and each configuration of the terminal device.

The controller 510 controls overall operations of the first and second terminal devices 100 and 500. In particular, the controller 510 controls the electronic commerce service provided to the first terminal 100 in association with the electronic commerce server 200.

On the other hand, the controller 510 may control an image processing operation with reference to a marker set in the image. The marker may be the information identification code or the image of package of the delivery item. The controller 510 may change at least one of a type, position, size, color, shape, orientation, and state of a subject in the output image in accordance with a position and orientation of the marker that changes according to the movement of the camera.

In particular, the controller 510 in the second terminal device 500 may check the marker of the identification code in the captured image and control the position of the marker to be displayed with the information related to the item by superimposing the position of the marker with the information related to the item under a control of the application program. When the marker is not recognized by the second terminal device 500 as the user moves the second terminal device 500, the controller 510 may inform the user that an alignment is required. Further, the controller 510 may perform necessary steps for superimposing the item-related data on the image currently being photographed.

In addition, the controller 510 of the present disclosure can control rotation, translation, and modification of the information related to the item when outputting the information related to the item.

The camera unit 530 may activate the camera under a control of the application program. Also, the camera unit 530 may provide the guide mark on a real-time camera image displayed on the terminal to facilitate positioning of the information identification code within the frame of the camera. If the identification code is positioned inside the frame of the camera, the camera unit 530 may recognize the identification code. Each of the first and second terminal devices 100 and 500 may include a front camera and a rear camera, so that the rear camera captures the information identification code and the front camera may capture the facial image of the user.

The biometric information recognition unit 540 can recognize the biometric information of the user to identify the user. The biometric information that can be recognized by the biometric information recognition unit 540 may include the iris recognition, the fingerprint information, and the like.

The identification of the user may be performed by the second terminal device 500 or the information providing server 400. In case that the identification of the user is performed by the second terminal device 500, the second terminal device 500 may extract the identification information of the recipient from the information identification code to compare with the information of the user.

The storage unit 550 may store the item information received from the first terminal device. In particular, the storage unit 550 according to the present disclosure may store the application program which is distributed by the electronic commerce server 200 and downloaded from an application store server (not shown).

The storage unit 550 may include a storage medium such as a random access memory (RAM), a read-only memory (ROM), a hard disk (HDD), a flash memory, a compact disc read-only memory (CD-ROM), and a digital versatile disc (DVD) as well as other storage medium such as a network access storage (NAS).

The input unit 560 generates a user input signal in response to a touch input or manipulation input of the user. The input unit 560 may be implemented by a variety of input devices. For example, the input unit 560 may include at least one of a key input device, a touch input device, a gesture input device, and a voice input device. The key input device may include a keypad or a keyboard having a plurality of keys and generate a signal corresponding to each of the plurality of keys when the key is manipulated by the user. The touch input device may be a touch pad, a touch screen, or a touch sensor, which recognize an input operation by sensing the user's touch of a specific portion. The gesture input device may include at least one of: a geomagnetic sensor, an acceleration sensor, a camera, an altimeter, a gyro sensor, and a proximity sensor to detect and recognize a predetermined movement or gesture of the user such as a shaking or moving of the terminal device, an approach to the terminal device, an eye blinking, or the like as a specific input signal.

The output unit 570 may output a series of operating states and operation results during the operation of the second terminal device 500 under a control of the controller 510. In particular, according to the present disclosure, the output unit 570 may output the information related to the item corresponding to the information identification code product in the augmented reality so that the user can realistically perceive the information related to the item.

The output unit 570 may be implemented by a display device such as a liquid crystal display (LCD), a thin film transistor LCD (TFT-LCD), a light emitting diode (LED), an organic light emitting diode (OLED), an active-matrix organic light emitting diode (AMOLED), a flexible display, or a three-dimensional display.

The input unit 560 and the output unit 570 may be incorporated into a single touch panel screen that may perform both the input and output functions.

The second terminal device 500 having the above-described configuration may capture the image of the information identification code, receive the information related to the item from the information providing server 400 after the authentication process, and outputs the information related to the item as the augmented reality. The communication unit 520 of the second terminal device 500 may store the information received from the information providing server 400 into the storage unit 550.

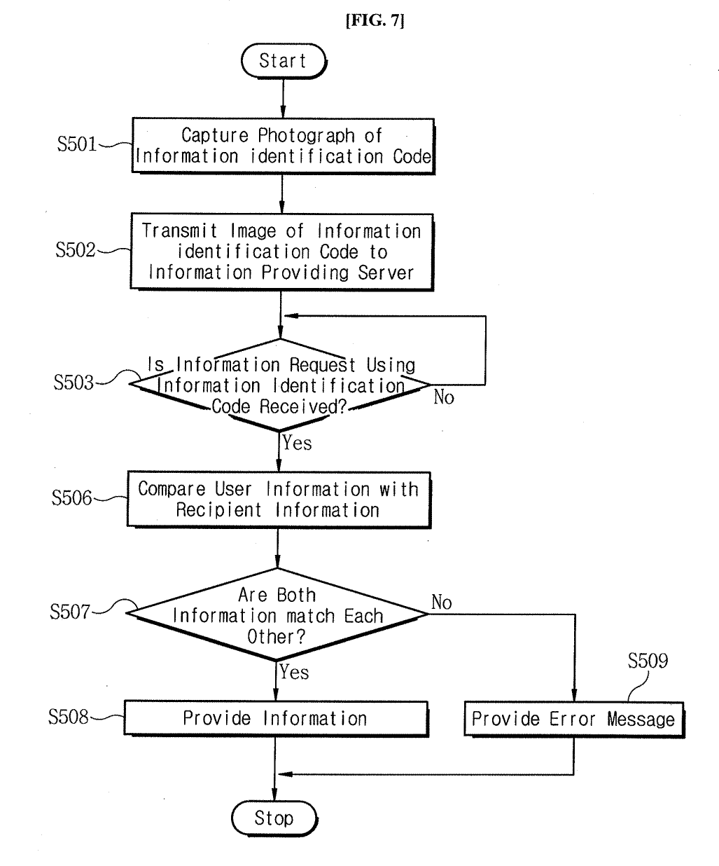

FIG. 7 is a flowchart illustrating an operation of the second terminal device 500 according to an embodiment of the present disclosure.

Referring to FIG. 7, the second terminal device 500 captures the image of the information identification code through the second terminal device 500 (S501), and recognizes the image of the information identification code. The second terminal device 500 transmits the recognition result of the information identification code (e.g. decoded information identification code or the image of the information identification code) to the information providing server 400 (S502).

At this time, when there are a plurality of item information corresponding to the information identification code, the information providing server 400 may choose one of the plurality of item information according to the user identification information of the second terminal device 500 and transmit the information related to the item to the second terminal device 500. Alternatively, the information providing server 400 may transmit a list of the information related to the item to second terminal device 500, so that the user of the second terminal device 500 may choose one item information in the list. Upon receiving the list of the item information corresponding to the information identification code from the information providing server 400, the second terminal device 500 may output the list by combining the list with the real-time camera image. The application program stored in the second terminal device 500 may be used to perform this process.

Afterwards, the second terminal device 500 may request the information providing server 400 to provide the information by use of the information identification code (S503), and compare the information of the legitimate recipient received from the information providing server 400 with the user information of the second terminal device 500 (S506).

If it is determined that the information of the legitimate recipient is identical to the user information, the second terminal device 500 receives the information related to the item from the information providing server 400 to output in the augmented reality (S508). If, however, it is determined that the information of the legitimate recipient is different from the user information, the second terminal device 500 may provide an error message informing that the information cannot be provided because the user is not the legitimate recipient (S509)

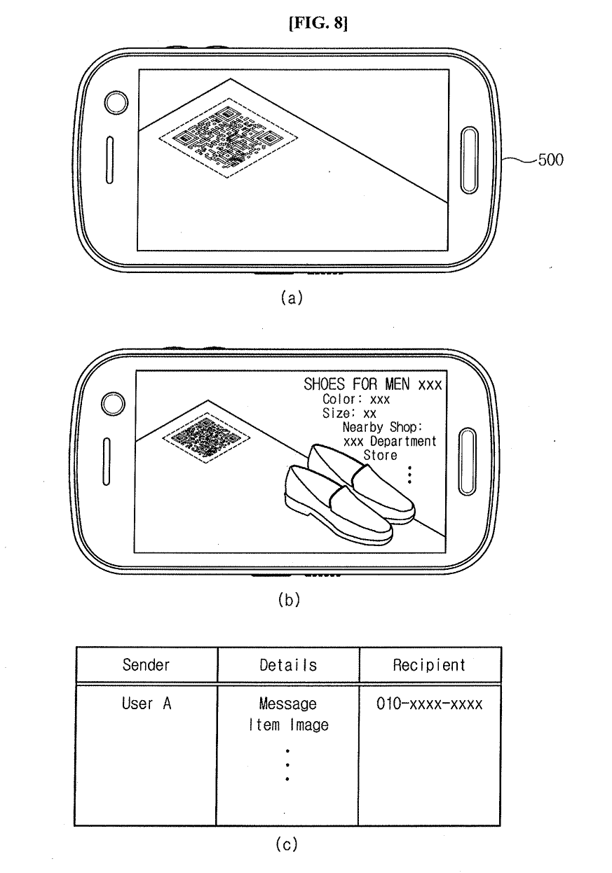

FIGS. 8A and 8B are exemplary screenshots of the second terminal device 500 for explaining a process of providing the information related to the delivery item based on the augmented reality according to an embodiment of the present disclosure.

FIG. 8A is an exemplary screenshot of the second terminal device 500 in a state of capturing the information identification code attached to the delivery item. The camera module 530 may provide a guide mark on the real-time camera image displayed on the second terminal device 500 to facilitate positioning of the information identification code within the frame of the camera. If the information identification code is positioned inside the frame of the camera, the camera module 530 may recognize the identification code.

FIG. 8B is an exemplary screenshot of the second terminal device 500 in a state of outputting the information related to the item received from the information providing server 400 in the augmented reality. At this time, the information related to the delivery item such as the brand name of the item, the model number of the item, the color of the item, the size of the item, and the information of a nearby shops may be acquired from the information providing server 400 and displayed together with the real-time image of the package.

Such information may be output in combination with the real-time image of the delivery item package captured by the camera. At this time, the information may be displayed along with various animation effects such as an animation effect of removing the package of the delivery item.

Also, when the user moves (rotates, tilts, enlarges/reduces) the camera, the type of the displayed information may be changed according to the movement of the camera such as the rotation, tilting, and zooming.

FIG. 8C is an exemplary table showing fields of a database maintained by the delivery service server 300. As shown in the drawing, the information related to the delivery item includes the sender information (‘user A’), details of the item, and the recipient information (e.g. a mobile telephone number of ‘010-xxxx-xxxx’) which are maintained in a mapping state. In this example, the details of the item may include the message of the sender and the image of the item.

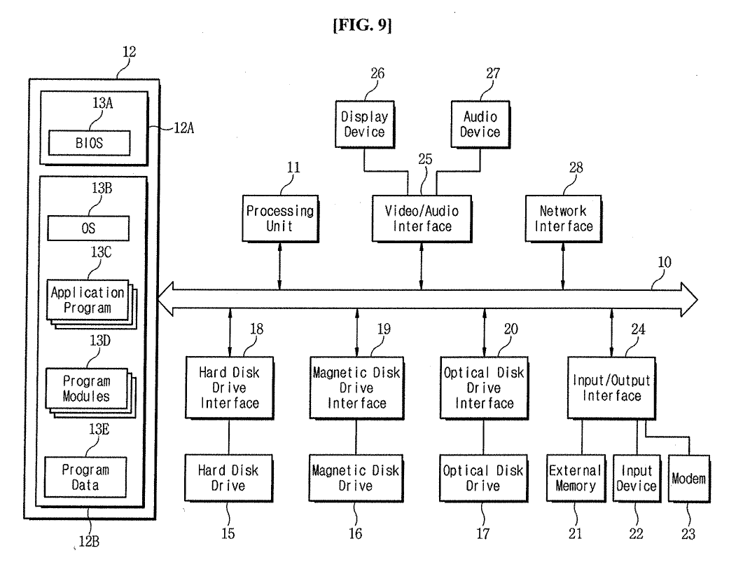

The service of providing the delivery information related to the item of the present disclosure can be provided through an interworking of the information providing server 400 and the second terminal device 500. The information providing server 400 and the second terminal device 500 can perform the service according to the present disclosure by executing a program implemented to perform the service procedure described above in a computing environment shown in FIG. 9.

FIG. 9 is a block diagram illustrating a computing environment of the information providing server 400 or the second terminal device 500 for implementing the method of providing the information related to the delivery item based on the augmented reality.

FIG. 9 and the following description are intended to provide a brief and general description of a suitable computing environment in which the present disclosure may be implemented. Although it is not required, the present disclosure may be described in connection with computer-executable instructions such as program modules that may be executed by a computer system. Generally, the program modules include routines, programs, objects, components, data structures, and so on suitable for performing particular tasks or implementing particular abstract data types. The computer-executable instructions, associated data structures, and program modules exemplify the program code means for carrying out processes described herein.

Referring to FIG. 9, an exemplary computing system suitable for implementing the present disclosure may include a processing unit 11, a system memory 12, and a system bus 10 that connects various system components including the system memory 12 to the processing unit 11.

The processing unit 11 is capable of executing computer-executable instructions designed to implement the features of the present disclosure.

The system bus 10 may be any of several types of bus architectures including a local bus, an external bus, and a memory bus. Alternatively, the system bus 10 may be any of the bus architectures employing a memory controller. The system memory 12 includes a read-only memory (ROM) 12A and a random access memory 12B. A Basic Input/Output System (BIOS) 13A which includes basic routines that help information transfer between components within the computing system when the system is booted may generally be stored in the ROM 12A.

The computing system may include storage devices. For example, the computing system may include a hard disk drive 15 that reads information from or writes information to a hard disk, a magnetic disk drive 16 that reads information from or writes information to a magnetic disk, and an optical disk drive 17 that reads information from or writes information to an optical disk such as a CD-ROM and other optical medium. The hard disk drive 15, the magnetic disk drive 16, and the optical disk drive 17 may be connected to the system bus 10 by a hard disk drive interface 18, a magnetic disk drive interface 19, and an optical drive interface 20, respectively.

Also, the computing system may further include an external memory 21 as one kind of the storage device. The external memory 21 may be connected to the system bus 10 through an input/output (I/O) interface 24.

The above-described drives and the computer-readable media that may be accessed by the drives allows nonvolatile storage of computer-executable instructions, data structures, program modules, and other data. The exemplary environment described herein illustrates the hard disk 15, the magnetic disk 16, and the optical disk 17, but other types of computer-readable media for storing data such as a magnetic cassette, a flash memory card, a DVD, a Bernoulli cartridge, a RAM, and a ROM may be used as well.

The program code means including one or more program modules that may be loaded and executed by the processing unit 11 and includes an operating system 13B, one or more application programs 13C, other program modules 13D, and program data 13E may be stored in the hard disk 15, the magnetic disk 16, the optical disk 17, the ROM 12A or the RAM 12B.

Also, the computing system may receive commands and information from a user through input devices 22 such as a keyboard, a pointing device, a microphone, a joystick, a game pad, and a scanner. These input devices 22 may be connected to the processing unit 11 via the I/O interface 24 connected to the system bus 10. The I/O interface 24 may logically represent at least one or a combinations of various interfaces such as, for example, a serial port interface, a PS/2 interface, a parallel port interface, a USB interface, an Institute of Electrical and Electronics Engineers (IEEE) 1394 interface (i.e., FireWire interface), and other interfaces.

In addition, the computing system may further include a display device 26 such as a monitor and a liquid crystal display (LCD), and an audio device 27 such as a speaker and a microphone. The display device 26 and the audio device 27 may be connected to the system bus 10 through a video/audio interface 25. Other peripheral devices (not shown) such as a speaker and a printer, for example, may be connected to the computing system. The video/audio interface 25 may include a High Definition Multimedia Interface (HDMI) and Graphics Device Interface (GDI).

The computing system may be connected to a network such as, for example, an office wide area network (WAN) or an enterprise WAN, a home network, Intranet, and/or Internet. The computing system may exchange data with external sources such as, for example, a remote computer system, a remote application, and/or a remote database.

To this end, the computing system may include a network interface 28 for receiving data from an external source and/or transmitting data to the external source.

The computing system may transmit and receive information to and from a remote device through the network interface 28.

For example, in case that the computing system refers to the first and second terminals 100 and 500, the first and second terminals 100 and 500 can communicate with the electronic commerce server 200 through the network interface 28. On the other hand, in case that the computing system refers to the electronic commerce server 200, the electronic commerce server 200 can communicate with the first and second terminals 100 and 500 through the network interface 27. The network interface 28 may represent a network interface card, or an equivalent software such as a network driver interface specification (NDIS) stack, an equivalent hardware, and/or a logical combination of the software and hardware.

Likewise, the computing system may transmit and receive data to and from an external source through the I/O interface 24. The I/O interface 24 may be connected to a modem 23 such as a standard modem, a cable modem, and a digital subscriber line (DSL) modem. The computing system may transmit and receive data to and from the external source through the modem 23.

Although FIG. 9 shows an operating environment suitable for the present disclosure, the principles of the present disclosure may be applicable to any other system capable of implementing the principles of the present disclosure with appropriate modifications, if necessary. The environment shown in FIG. 9 is illustrative only and does not represent even a small portion of various environments in which the principles of the present disclosure may be implemented.

In addition, various information generated during the execution of the program according to the present disclosure may be stored and accessed in a computer-readable medium related with the computing system. For example, a portion of these program modules and a portion of the associated program data may be included in the operating system 13B, the application program 13C, the program module 13D, and/or the program data 13E to be stored in the system memory 12.

Further, when a mass storage device such as the hard disk is connected to the computing system, such program module and related program data may be stored in the mass storage device. In a networked environment, the program modules associated with the present disclosure, or portions thereof, may be stored in a remote computer system connected via the I/O interface 24 and the modem 23 or the network interface 25. The execution of such a module may be performed in a distributed environment as described above.

While the present specification contains a number of specific implementation details, it should be understood that they are not to be construed as limitations on the scope of any disclosure or claims, but as a description of features that may be specific to a particular embodiment of a particular disclosure. Certain features described with respect to contexts of independent embodiments may be implemented in combination in a single embodiment. Conversely, various features described in the context of a single embodiment may also be implemented in other embodiments either individually or in any suitable sub-combination. Further, although some features may be described to operate in a particular combination and may be initially depicted as so claimed, one or more features from the claimed combination may in some cases be excluded from the combination, and a claimed combination may be replaced by a sub-combination or a variant of the sub-combination.

Similarly, although the operations are depicted in the drawings in a particular order, it should not be understood that such operations need to be performed in that particular order or sequential order shown to achieve the desired result or all the depicted operations should be performed. In certain cases, multitasking and parallel processing may be advantageous. Also, the fragmentation of the various system components in the above-described embodiments should not be understood as requiring such fragmentation in all embodiments, and the program components and systems described above may generally be integrated together into a single software product or packaged into a multiple-function software product.

Although specific embodiments of the subject matter have been described herein, other embodiments are within the scope of the following claims. For example, the operations defined in the claims may be performed in a different order to still achieve desirable results. By way of example, the process illustrated in the accompanied drawings does not necessarily require that particularly illustrated sequence or sequential order to achieve the desired result. In certain implementations, multitasking and parallel processing may be advantageous.

The descriptions set forth above disclose the best mode of the present disclosure, and is provided to illustrate the disclosure and to enable those skilled in the art to make and use the disclosure. The written description is not intended to limit the disclosure to the specific terminology presented. Thus, although the present disclosure has been described in detail with reference to the above examples, those skilled in the art will be able to make adaptations, modifications, and variations on the examples without departing from the scope of the present disclosure.

As described above, according to the present disclosure, the recipient can check or fine the information related to the delivery item in the augmented reality. Thus, the recipient can grasp the information related to the delivery vividly without removing the package upon receipt of the delivery item. Also, the recipient can promptly determine whether or not to receive the item upon receipt of the item.

The description of the disclosure is merely exemplary in nature and, thus, variations that do not depart from the substance of the disclosure are intended to be within the scope of the disclosure. Such variations are not to be regarded as a departure from the spirit and scope of the disclosure.

1. A method of providing information based on augmented reality in a device, comprising:
capturing, by using a camera of the device, an image of a package to which an information identification code is attached;
recognizing the information identification code from the captured image of the package;
accessing an information providing server based on the recognized information identification code to request information related to an delivery item contained in the package;
receiving the requested information related to the delivery item from the information providing server; and
combining the received information related to the delivery item with the captured image of the package to output in the augmented reality.

2. The method of claim 1, wherein the information related to the delivery item contains at least one of: an image, manufacture or production information, seller contact information, an instruction manual, a history, sender information, and recipient information of the delivery item, and a message sent by the sender to the recipient.

3. The method of claim 1, wherein combining the information with the image of the package to output in the augmented reality comprises:
displaying the information related to the item by combining with the image of the package on a basis of a marker displayed on the image of the package.

4. The method of claim 3, wherein the marker is the information identification code or the image of the package.

5. The method of claim 1, wherein combining the information with the image of the package to output in the augmented reality comprises:
changing at least one of a type, position, size, color, shape, orientation, and state of output information according to a position and orientation of the marker that change with a movement of the camera.

6. The method of claim 2, wherein the message sent by the sender to the recipient includes at least one of: an image, a moving picture, a text, and a voice message.

7. The method of claim 2, wherein the message sent by the sender to the recipient is associated with a network-based communication service including at least one of: a social network service (SNS), an instant messenger service, an e-mail, a short message service (SMS), and a multimedia message service (MMS).

8. The method of claim 1, wherein accessing the information providing server to request information related to the delivery item comprises:
acquiring recipient information, suitable for identifying the recipient, including at least one of: an IP address, a MAC address, and a mobile communication number assigned to the device, and a facial image and biometric information of the recipient; and
transmitting acquired recipient information, to the information providing server for use in authenticating the recipient.

9. The method of claim 8, further comprising at least one of:
capturing a facial image of the recipient, as the recipient information, by using the camera of the device; and
recognizing a fingerprint of the recipient, as the recipient information, by using a fingerprint recognition sensor of the device.

10. The method of claim 1, wherein the information identification code is a matrix code including at least one of: a quick response (QR) code, a two-dimensional barcode, and a color barcode.

11. An information providing server, comprising:
a communication unit configured to communicate with of a first terminal device, an electronic commerce server, and a delivery service server;
a storage unit configured to store information related to an item provided by a sender; and
an identification code generator configured to generate an information identification code for accessing the information related to the item; and
a controller configured to transmit the information identification code to one of the first terminal device, the electronic commerce server, and the delivery service server. receive an information request using the information identification code from a second terminal device, and transmit the information related to the item contained in a package corresponding to the information identification code to the second terminal device.

12. The information providing server of claim 11, wherein the storage unit receives reference recipient information for the recipient to receive an augmented reality-based item information, and
wherein the controller compares information of the user receiving the package with the reference recipient information and transmits the at least one information related to the item contained in the package to the second terminal device only when the information of the user receiving the package coincides with the reference recipient information.

13. A device comprising:
a communication unit configured to communicate with an information providing server;
a camera unit configured to capture an image of an information identification code and a facial image of a recipient;
a biometric information recognition unit configured to recognize biometric information of the recipient;
a controller configured to request information related to an item from the information providing server, receive the requested information, and combine the received information with an image of a package of the item to output in an augmented reality; and
a storage unit configured to store the received information related to the item.

14. The device of claim 13, wherein the controller changes at least one of a type, position, size, color, shape, orientation, and state of output information according to a position and orientation of a marker that change with a movement of the camera, and
wherein the marker is the information identification code or the image of the package.
